(19) United States
(12) Patent Application Publication
(10) Pub. No.: US 2010/0290386 A1
(43) Pub. Date: Nov. 18, 2010

(54) WIRELESS RELAY CONTROLLER FOR HOME AUTOMATION

(75) Inventors: Alfredo CABRAL HINOJOSA, TOLUCA (MX); Alejandro ROMERO VARGAS, TEMIXCO MORELOS (MX)

Correspondence Address: GRAYBEAL JACKSON LLP, 400 - 108TH AVENUE NE, SUITE 700, BELLEVUE, WA, 98004, US

(73) Assignee: SYNERGY ELEMENTS, INC., EVERETT, WA (US)

(21) Appl. No.: 12/781,729

(22) Filed: May 17, 2010

Related U.S. Application Data
(60) Provisional application No. 61/178,883, filed on May 15, 2009.

(51) Int. Cl. H04B 7/14

(52) U.S. Cl. 370/315

(57) ABSTRACT

A wireless relay controller for a home automation system may remain in a sleep state until an addressed command is received, wake from the sleep state and actuate a bi-stable relay responsive to receiving the addressed command, and then enter the sleep state after execution of the command.

### PRIORITY CLAIM

The present application claims priority to U.S. Provisional Patent Application No. 61/178,883, filed May 15, 2009, which application is incorporated herein by reference in its entirety.

### BACKGROUND

In home automation systems, multi-channel relay controllers have typically been deployed in a control cabinet, for example near the breaker panel of a home. This centralized installation generally requires extensive control cabling to appliances that are controlled by the multi-channel relay controller. Centralized multi-channel relay controllers may typically consume significant power and be physically large. Typically, conventional multi-channel relay controllers require professional installation and may also be relatively costly.

### SUMMARY

According to an embodiment, a wireless relay controller is configured for deployment in relatively close proximity a controlled appliance, thus minimizing cable costs and reducing or eliminating professional installation labor. Compared to centralized multi-channel relay controllers, the present wireless relay controller may be distributed throughout a residence at any location where control is desired. Such distribution may provide easy expansion and modification, and allow the apparatus to be installed by a homeowner rather than a professional electrician.

In a home automation system, several components may communicate to control electrical circuits and/or actuators. According to an embodiment, a wireless relay controller is configured for deployment local to an appliance that is controlled by one or more relays in the wireless relay controller. The wireless relay controller may receive commands from other components of a home automation system, for example, via a radio frequency interface such as ZigBee™. The wireless relay controller may be battery-powered. According to an embodiment, the wireless relay controller includes a controller and data interface configured to be in sleep mode when not responding to a command. According to an embodiment, dry contact relays in the controller may be bi-stable and consume power only when switching states.

According to an embodiment, the wireless relay controller may be configurable to execute simple or explicit commands received from a network resource. According to an embodiment, the wireless relay controller may be configurable to execute complex or implicit commands received from a network including a plurality of relay actuations responsive to a single command.

According to an embodiment, the wireless relay controller may include a ZigBee wireless interface configured to operate as a ZigBee™ End Device (ZED). According to an embodiment, the wireless relay controller may include a ZigBee™ wireless interface configured to operate as a ZigBee™ Router (ZR).

According to an embodiment, a wireless relay controller includes a controller; a network interface operatively coupled to the controller; and at least one bi-stable relay operatively coupled to the controller; wherein the controller and network interface are configured to remain in a sleep mode when not receiving a command.

According to an embodiment, a wireless relay controller includes a network interface configured to receive a first command from a network; a controller operatively coupled to the network interface and configured to receive the first command and responsively generate output a plurality of relay actuation signals corresponding to the first command; and one or more relays operatively coupled to the controller and configured to operate responsive to the plurality of relay actuation signals.

According to an embodiment, a method for operating a wireless relay controller, includes receiving a first command via a network interface and, responsive to the first command, performing a plurality of relay actuations.

According to an embodiment, a method for operating a wireless relay controller includes receiving a first command with a wake-up circuit, the first command being addressed to a wireless relay controller; performing a wake-up command responsive to the first command to wake a controller in the wireless relay controller from a sleep state; actuating at least one bi-stable relay responsive to the first command; and performing a sleep command to put the controller into the sleep state.

According to an embodiment, a method for operating a wireless relay controller includes transmitting at least one configuration command to a wireless relay controller, the at least one configuration command including instructions to execute a plurality of relay actuations responsive to receipt of a complex actuation command; and transmitting to the wireless relay controller, the complex actuation command.

### BRIEF DESCRIPTION OF THE FIGURES

FIG. 1 is a block diagram of a wireless relay controller for home automation, according to an embodiment.

FIG. 2A is a flowchart of a process for operating the wireless relay controller, according to an embodiment.

FIG. 2B is a flowchart of a process for operating the wireless relay controller, according to another embodiment.

FIG. 3 is a perspective view of an electronics assembly for the wireless relay controller, according to an embodiment.

FIG. 4A is a perspective view of a packaged wireless relay controller, according to an embodiment.

FIG. 4B is a top view of a packaged wireless relay controller, according to an embodiment.

FIG. 4C is an end view of the packaged wireless relay controller, according to an embodiment.

FIG. 5 is a perspective view of a wireless relay controller configured to at least optionally receive AC power, according to an embodiment.

FIG. 6 is a block diagram of a wireless relay controller configured to at least optionally receive AC power, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

As used herein, the term “appliance” shall be taken to mean an apparatus, device, system, or component that may be controlled by wires coupled to the wireless relay controller described herein. For example, an appliance may include an air conditioner, a heater, a furnace, a heat pump, a gas fireplace, a fan, a sprinkler valve, a generator, or other electrically-actuatable object. An appliance may similarly refer to a home appliance such as a refrigerator, a freezer, a range, a dishwasher, a washer, a dryer, a trash compactor, etc. An appliance may similarly refer to two electrical circuits that may be selectively coupled by the wireless relay controller. An appliance may similarly apply to an electrically-powered apparatus that may be plugged into an AC socket such as a lamp or luminaire, a computer, an entertainment system, or a chargeable electric or hybrid vehicle.

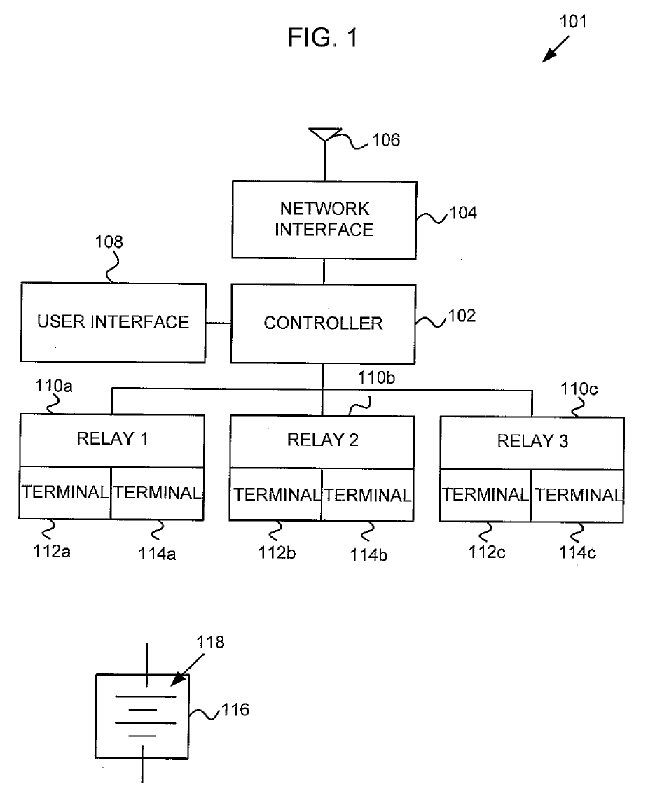

FIG. 1 is a block diagram of a wireless relay controller for home automation 101, according to an embodiment. The wireless relay controller 101 may include a controller 102. The controller 102 is operatively coupled to a network interface 104. The network interface 104 may include an unlicensed radio interface such as ZigBee™, Bluetooth™, IEEE 802.11x, Z-wave™, or the like. The network interface 104 may also include one or more antennas 106 configured to receive and/or transmit data signals from and/or to other components of the home automation system. For example, the one or more antennas 106 may be formed as electrical traces disposed on a printed circuit board supporting the controller 102 and network interface 104. The network interface 104 may be a contained on a physically separated IC from the controller 102 or be abstracted as a parallel process.

According to an embodiment, at least portions of the controller 102 and network interface 104 may be disposed on a common integrated circuit. According to an embodiment, substantially the entirety of the controller 102 and the network interface 104 may be disposed on a common integrated circuit plus peripheral circuitry. For example, the controller 102 and network interface 104 may be embodied as a FREESCALE™ part number MC13213. Alternatively, the controller 102 and network interface 104 may be embodied as separate parts. For example, a network interface 104 may be embodied as a FREESCALE™ part number MC13202 transceiver. For example, a separate controller 102 may be embodied as an ARM microcontroller. For example, a separate controller 102 may be embodied as a FREESCALE™ part number MC9S08QE 8-bit microcontroller. Other alternative partitioning may be substituted according to designer preferences.

A user interface 108 may receive control and/or inquiry input from a user. The user interface 108 may also provide information to the user. For example the user interface 108 may include one or more LED indicator lights and one or more buttons. Optionally, the user interface 108 may include a display such as a LCD display configured to present messages or iconography to the user.

The controller 102 may be operatively coupled to one or more relay switches Relay 1, Relay 2, and Relay 3, 110a, 110b, and 110c, respectively. Responsive to a command received via the network interface 104, the controller may output one or more control signals to the one or more relay switches 110a, 110b, 110c to open or close. According to an embodiment, the one or more relay switches 110a, 110b, 110c may include a dry contact relay that is bi-stable (latched) open or closed. A bi-stable relay switch 110a, 110b, 110c may be configured to consume power only when changing states, and consume substantially no power when maintaining a state. For example the one or more relay switches 110a, 110b, 110c may include a latching-type 2.4V DC DPDT dry contact power relay such as an AXICOM™ part number IM48DGR, available from TYCO ELECTRONICS™, Harrisburg, Pa. The one or more relay switches 110a, 110b, 110c may each include corresponding terminals. For example a relay switch 110a may include a first terminal 112a and a second terminal 114a configured to couple to control wires (not shown) from an appliance, with the relay switch 110a being configured to selectively open or close a circuit including the control wires responsive to a command from the controller 102. Alternatively, the terminals 112a, 114a may be configured as an AC electrical socket.

Optionally, other types of relays 110 may be used. For example solid state relays such as MOSFET devices or other semiconductor relays may be used. Optionally, the relay or relays 110 may be integrated into other devices.

The wireless relay controller 101 may include a battery holder 116 configured to receive one or more batteries 118 for powering the wireless relay controller 101. For example, the battery holder 116 may be configured to receive three AAA cells. The AAA cells may be conventional alkaline, NiCd, NiMH, lithium-ion, lithium polymer, or other battery types. Additionally or alternatively, the wireless relay controller may include one or more connectors (not shown) for receiving power from an external source.

One or more of the controller 102, the network interface 104, the user interface 108, and the one or more relays 110a, 110b, and 110c may be configured to consume little or no energy when not activated to change the state of one or more of the relays 110a, 110b, and 110c.

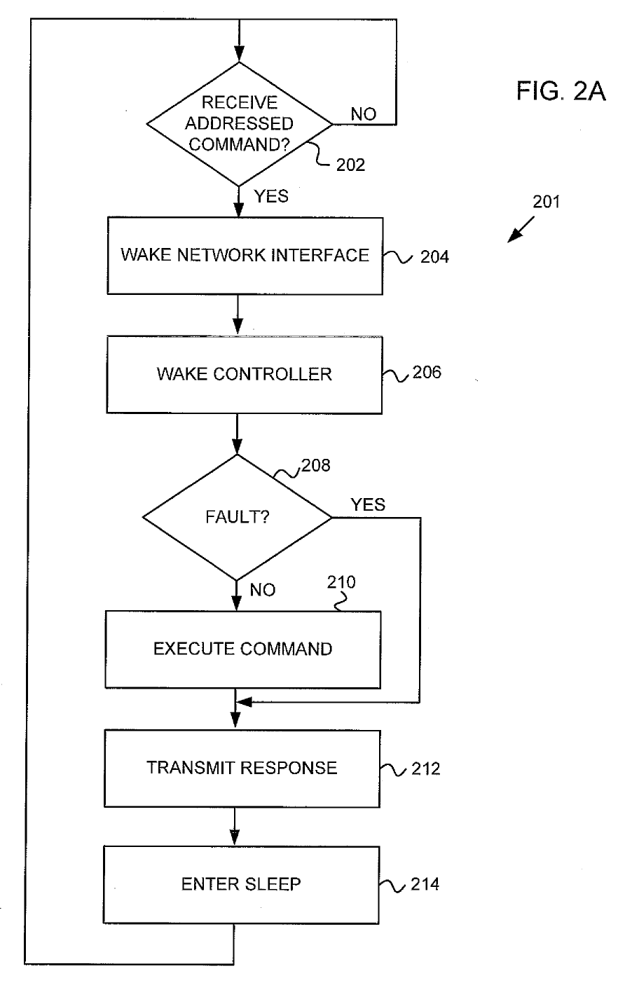

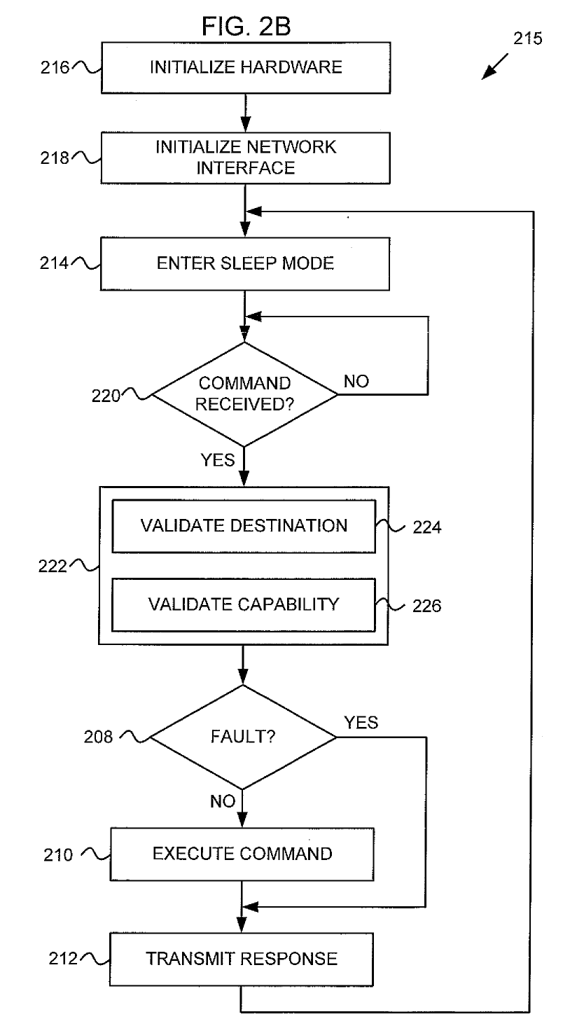

FIG. 2A is a flowchart of a process 201 for operating the wireless relay controller 101 shown in FIG. 1, according to an embodiment. The process of FIG. 2A may be used, for example, in an embodiment of the wireless relay controller 101 having a hardware wake-up circuit.

Normally the wireless relay controller 101 stays in a sleep state. In the sleep state, substantially only a small portion of the network interface 104 including a wake-up circuit remains active. The wake-up circuit executes step 202 wherein received radio frequency messages are compared to a communication address of the wireless relay controller 101. The communication address of the wireless relay controller 101 may, for example, include a MAC address and/or logical address stored in the network interface 104 or other assigned address that may be accessed without waking other portions of the wireless relay controller 101. If a received radio frequency message does not include data indicating it is addressed to the wireless relay controller 101, then the wake-up circuit continues to execute step 202 without responding and without waking other portions of the wireless relay controller 101. If a received radio frequency message does include data indicating the message is addressed to the wireless relay controller 101, then the process 201 proceeds to step 204.

In step 204, the wake-up circuit in the network interface outputs a command or signal selected to wake the remainder of the network interface 104. Upon being activated, and still in step 204, the network interface 104 may optionally receive and/or transmit one or more handshake messages with the radio transceiver that initiated the communication. If the message is a ping or other message that does not require further action by the wireless relay controller 101, the process 201 may optionally proceed substantially directly from step 204 to step 214 and the network interface 104 may go back to sleep without consuming significant additional power.

Proceeding to step 206, the controller 102 receives a wake-up command. For example, waking the network interface 104 prior to waking the controller 102 may allow faster response to a message, and less power consumption in the event controller wake-up is not needed. Alternatively, steps 204 and 206 may be executed substantially simultaneously.

Proceeding to step 208, if a fault is detected, the process 201 may proceed directly to step 212 to transmit a message indicating the fault. For example, if battery power is too low to switch a relay or if switching may reduce battery power below what is required to operate the network interface 104 and/or controller 102, the process 201 may proceed from step 208 to step 212 to notify the system that batteries need to be changed. If, in step 208, no fault is detected, the process 201 may proceed to step 210, described in more detail below.

Optionally, the process 201 may then proceed to step 212. In step 212, the wireless relay controller 101 transmits a response to the initiating module, or alternatively transmits a broadcast response. The response may include data indicating compliance with the command to set the state of one or more relays 110a, 110b, 110c. Alternatively, the response may indicate non-compliance, a fault, a request to retransmit the command, etc.

Finally, the process 201 proceeds to step 214. In step 214, the wireless relay controller 101 enters sleep mode and returns to step 202. An advantage of entering sleep mode between actuations includes a significant reduction in power consumption compared to conventional relay controllers. This allows the wireless relay controller 101 to be deployed local to a controlled appliance, without necessitating providing power to the wireless relay controller beyond an amount provided by conventional (e.g., AAA or AA) batteries. Under normal conditions, batteries may provide sufficient power to operate the wireless relay controller 101 for the normal lifespan of the batteries, e.g. about three years.

FIG. 2B is a flowchart of a process 215 for operating the wireless relay controller 101, according to another embodiment. The process 215 illustrates an initialization process that may also be performed (but is not shown) with the process 201 shown in FIG. 2A. The process 215 of FIG. 2B may be performed, for example, in an embodiment of the wireless relay controller 101 not having a separate wake-up circuit.

Beginning in step 216, in a hardware initialization state all hardware is turned on and initialized. Default states for contact closures (e.g. normally on or normally off, momentary or latch) are set. The default values may be configured from an external system through a device interface, which may receive the values from a user or a network. When the network components are initialized, the process 215 proceeds to step 218.

In step 218, the device may register in a network. If this is not the first time this device runs the initial sequence, a previous registration setting may be retrieved from the system. Functional configuration may also set, according to device capabilities. If configuration profiles are available on the network, the wireless relay controller 101 may retrieve these settings from a remote location.

After the relay controller has been initialized, the process 215 proceeds to step 214, and the relay controller goes to a low power or “sleep” mode.

In sleep mode, the network interface receives messages such as radio frequency messages transmitted by other system resources. When no messages are received, the system loops at step 220 in a mode that minimizes power consumption. When a command is received, the process 215 proceeds to step 222.

Step 222 is a validation step that includes two types of validation. Step 224 is a destination validation and step 226 is a capability validation. In step 224, the device validates the packet destination. For example, the destination of the received command may be compared to a MAC address and/or logical address. Step 224 may also evaluate functionality published on the network. According to the ZigBee standard, clusters are an abstraction of local functionality. Such capability is available to remote devices on the network that can control a cluster. Further detail is available in the Zigbee Specification, available from the ZigBee Alliance, which incorporated herein by reference.

If it is determined that the packet received contains a valid destination that refers to the local device, then system capability is evaluated in step 226. For example, in step 226, the received command may be compared to the configuration profile of the wireless relay. This may include more advanced and/or specific criteria. For example, a relay controller may be exposed to the network as an HVAC controller, but a only limited set of commands are compliant with this functional profile. In this scenario HVAC controller capabilities may be validated by the network component, while the specific command may be validated by the behavior implementation and hardware control components.

The process next proceeds to step 208, where the results of validation are tested. If validation is made (i.e. if a fault is not detected), the process proceeds to step 210, where the command is executed. After execution of step 210, or if a fault is detected in step 208, the process proceeds to step 212 where a response is transmitted to the network. A response packet may include the success or unsuccessful result of attempting to execute a command. It also may include report of the system status.

Operation of step 210, shown in FIGS. 2A and 2B is described next.

Commands may include directives to change the state of the hardware systems, new configurations notification, request of system state or any other logical or functional application of the devices capabilities. For example, in step 210, one or more relays 110a, 110b, 110c may be actuated and latched into a new state. According to an embodiment, one or more of the relays 110a, 110b, 110c is momentarily driven with a voltage on set of pins to close the one or more relays 110a, 110b, 110c; or momentarily driven with an opposite voltage on the set of pins to open the one or more relays 110a, 110b, 110c. After setting the state of the one or more relays 110a, 110b, 110c, voltage may be removed and the switch position will be maintained in the selected stable position without consuming additional current. For example, a relay may consume about 100 milliwatts (mW) at 1.8 to 6.8 volts (or −1.8 to −6.8 volts) when switching, and then consume substantially 0 mW while remaining in an open or in a closed position.

According to an embodiment, the controller 102 may actuate one of the relays 110a, 110b, 110c (e.g. to the same or different states) responsive to a single first command received via the network interface 104. According to another embodiment, the controller 102 may actuate two or more relays 110a, 110b, 110c (e.g. to the same or different states) responsive to a single first command received via the network interface 104.

According to an embodiment, the response of the wireless relay controller 101 to a single first command may be programmable. For example, during a configuration step (not shown), flash memory or other non-volatile memory in the controller 102 may be programmed to provide a lookup table to set two or three relay states corresponding to a “turn-on” command and set another two or three relay states corresponding to an “turn-off” command. Additionally or alternatively, flash memory or other non-volatile memory in the controller 102 may be programmed to sequentially activate two or more relays 110a, 110b, 110c responsive to receipt of a “turn-on” or “turn-off” command. The receipt of a single first command corresponding to plural actuations may be referred to as receiving an implicit or a complex command from a network resource.

For example, the wireless relay controller 101 may be deployed to activate or turn off a generator. Relay 1 110a may be operatively coupled to a starter motor via terminals 112a, 114a. Relay 2 110b may be operatively coupled to the ignition via terminals 112b, 114b. Relay 3 110c may be operatively coupled to a kill switch via terminals 112c, 114c. Upon receipt of a “turn-on” command via the network interface 104, a microprocessor or microprocessor core in the controller 102 may execute the following sequence during step 210:

(After receipt of addressed “turn on” command to start generator)

1) Open relay 3 110c.

2) Close relay 2 110b.

3) Close relay 1 110a for 2.5 seconds, then open relay 1 110a.

Alternatively, sequential or substantially simultaneous actuation of two or more relays 110a, 110b, 110c may be performed responsive to explicit or simple first commands received from a network resource. For example, the sequence of relay actuations for starting a generator may be executed by receiving sequential commands through the network interface 104 according to the following sequence:
1) Receive addressed command to open relay 3 110c.
2) Execute steps 202 to 214 wherein step 210 includes opening relay 3 110c.
3) Receive addressed command to close relay 2 110b.
4) Execute steps 202 to 214 wherein step 210 includes closing relay 2 110b.
5) Receive addressed command to close relay 1 110a.
6) Execute steps 202 to 214 wherein step 210 includes closing relay 1 110a.
7) (After a 2.5 second delay) receive addressed command to open relay 1 110a.
8) Execute steps 202 to 214 wherein step 210 includes opening relay 1 110a.

As may be appreciated, programming the controller 102 to execute implicit or complex first commands by the process 201 may be performed with relatively fewer network commands, but may require somewhat greater controller 102 resources. Using the process 201 to perform a series of equivalent explicit or simple commands may require relatively more network commands, but may reduce the controller hardware requirements. Additionally or alternatively, the controller 102 may be programmed to respond to both explicit and implicit commands. This arrangement may provide for reduced network commands and for more sophisticated programming, flexibility, and/or response to manual input by a user through a network resource. For example, if a network resource determined that the generator failed to start responsive to the implicit/complex command example above, the network resource may elect to issue explicit/simple commands to the wireless relay controller 101 to crank the starter motor for a period longer than 2.5 seconds.

Optionally, relays may be commanded to sequentially open and close in a combination and/or sequence selected to encode data, such as digital data. For example, relay 1 110a may be configured to transmit (low bandwidth) information to another apparatus such as an appliance or external sensor. The controller 102 may sequentially open and close relay 1 110a according to a schedule corresponding to information encoding. For example, the controller may open and close relay 1 110a according to a chipping sequence selected to identify a transmission frequency and phase, and the controller may open and close relay 1 110a according to a variable phase such as to transmit a phase shift keyed (PSK) message. Alternatively other data coding techniques may be used. This may be used, for example, to transmit an address, an operation mode, new operating software, and/or a firmware upgrade to a coupled appliance or other device.

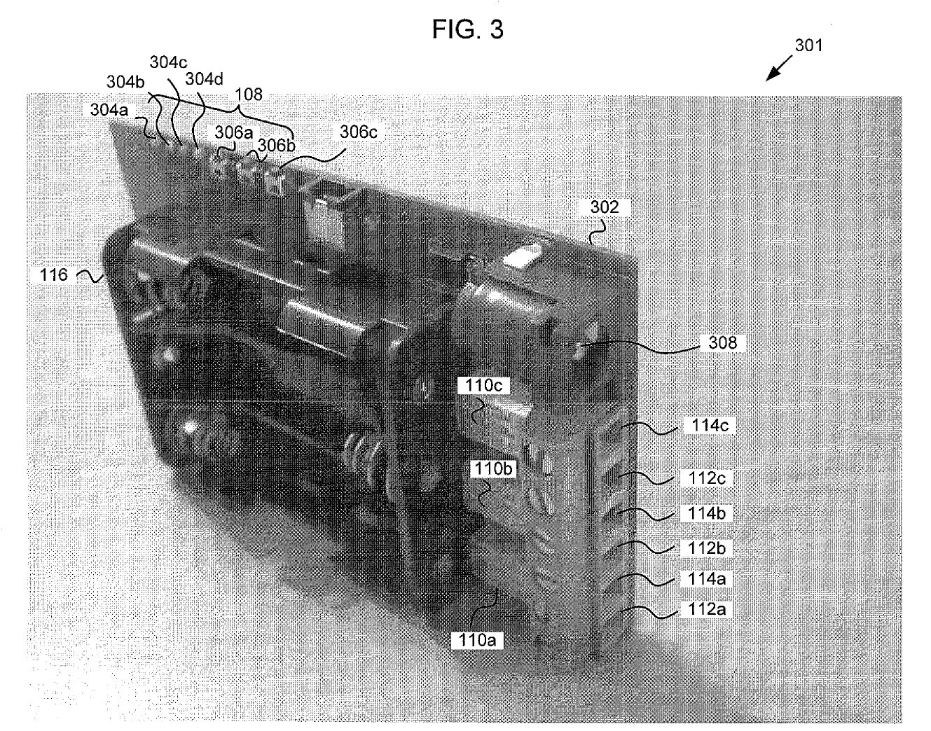

FIG. 3 is a perspective view of an electronics assembly 301 for the wireless relay controller 101, according to an embodiment. The electronics assembly 301 includes a printed circuit board 302 onto which electrical components are mounted. A battery holder 116 dominates one side of the printed circuit board 302. A user interface 108 includes one or more LEDs 304a, 304b, 304c, and 304d configured to provide wireless relay controller and/or network status information to a user. The human interface 108 also includes one or more buttons 306a, 306b, and 306d.

Three relays 110a, 110b, 110c are disposed next to corresponding terminals 112a, 114a, 112b, 114b, 112c, 114c. The terminals are aligned along the edge of the printed circuit board 302 to allow easy access for installation. A DC power connector 308 is provided near the terminals 112a, 114a, 112b, 114b, 112c, 114c to receive external power. It may be advantageous to provide external power especially when the wireless relay controller 101 is deployed in a very remote, hazardous, or otherwise inaccessible location where changing batteries every few months or years would be difficult. Alternatively, it may be advantageous to provide external power through the DC power connector 308 in rapid cycling applications where battery life may be reduced.

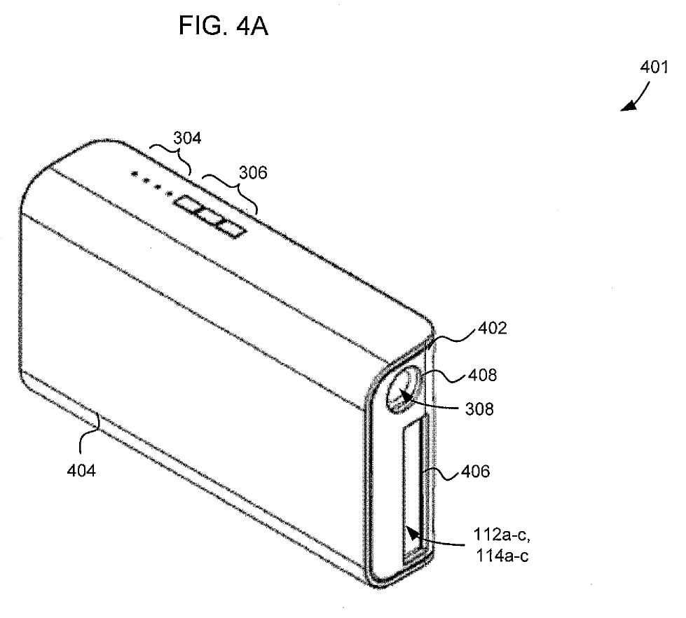

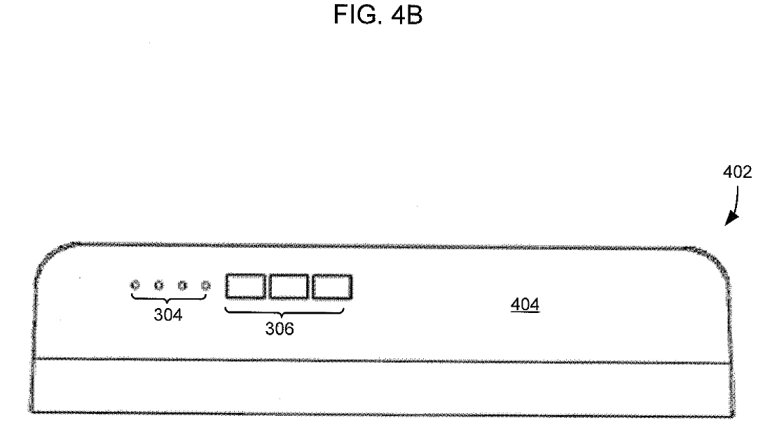

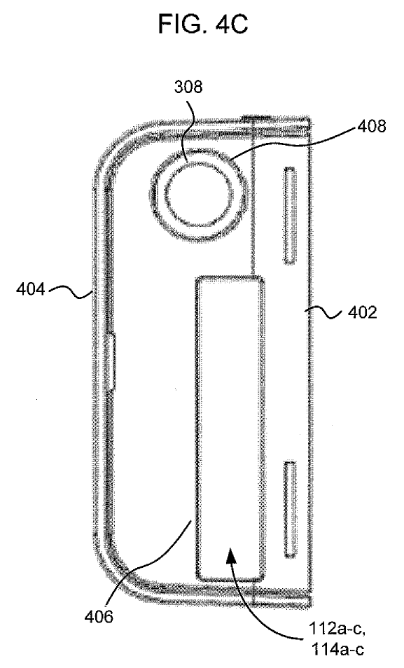

FIG. 4A is a perspective view of a packaged wireless relay controller 401, according to an embodiment. FIG. 4B is a top view of the packaged wireless relay controller 401, according to an embodiment. FIG. 4C is an end view of the packaged wireless relay controller 401, according to an embodiment.

With reference to FIGS. 4A-4C, the package includes a back plate 402 and a front cover 404, which may for example be made from a plastic or metal material. Optionally the back plate 402 and/or front cover 404 may be at least partially shielded to reduce electromagnetic interference. If shielded, a portion of the back plate 402 and front cover 404 should be left unshielded to allow radio frequency energy to reach the antenna (not shown). The back plate 402 and the front cover 404 may be formed as interlocking pieces that may be releasably coupled to one another. According to an embodiment, the front cover 404 may be removed from the back plate 402 by gently squeezing along the top and bottom edges to release mechanical latches (not shown) that couple the front cover 404 and back plate 402 together. The front cover 404 may be snapped into place over the back plate 402 by gently pushing the covers together until the mechanical latches (not shown) fall into detent holding positions. Removing the front cover 404 may provide ready access to the battery carrier (not shown) and the batteries.

The top of the wireless relay controller may include one or more LED indicators 304 and one or more control buttons 306. For example the one or more LED indicators may include momentary indication of a network communication, an indication of power on, an indication of a fault condition such as low battery, an indication of relay state or other indication that may be useful to a user. The one or more buttons 306 may include a display command, a power switch, and one or more manual “turn-on”/“turn-off” command toggles, for example. To conserve battery power, the LED indicators may be normally off. Upon receipt of a display command, the LED indicators may illuminate according to their illumination conditions for at time sufficient for a user to determine the operational state of the wireless relay controller 101. The LEDs may further be context-sensitive and carry different meanings in different operational modes.

The end of the wireless relay controller includes an aperture 406 for access to the terminals 112a, 114a, 112b, 114b, 112c, and 114c. Typically the front cover 404 may be removed to provide access to the terminal screws. Alternatively or additionally, the terminals 112a, 114a, 112b, 114b, 112c, 114c may include ratchet-type terminals that allow insertion of a wire and then hold the wire. The first end of the wireless relay controller 101 also includes an aperture 408 for access to the DC power connector 308.

The back plate 402 may optionally include integrated mounting features (not shown) and/or mounting features configured to couple to mounting hardware. For example one or more screw keyholes, one or more adhesive mounting pads, one or more screw holes, one or more features for mounting to a fire alarm base, one or more legs, one or more hooks and/or eyes, a hook-and-loop fastener pad, and or other features may be provided for permanently or reversibly couple the wireless relay controller 101 to a wall of a home, a shelf, a ceiling, or other mounting surface.

As may be appreciated by comparison to the size of the AAA battery holder in FIG. 3, the wireless relay controller 101 may be quite small. According to an embodiment, the longest outer dimensions of the packaging shown in FIGS. 4A-4G may be smaller than a credit card. Total outside dimensions may be about 81 mm wide by 46 mm high by 20 mm thick. This small size may further provide for easy integration in contact with or in proximity to an appliance controlled by the wireless relay controller 101.

As mentioned above, the wireless relay controller 101 may alternatively or additionally be configured to receive AC power. Received AC power may be used in a version of the product that is powered by AC only. Alternatively, the received AC power may be used to charge batteries.

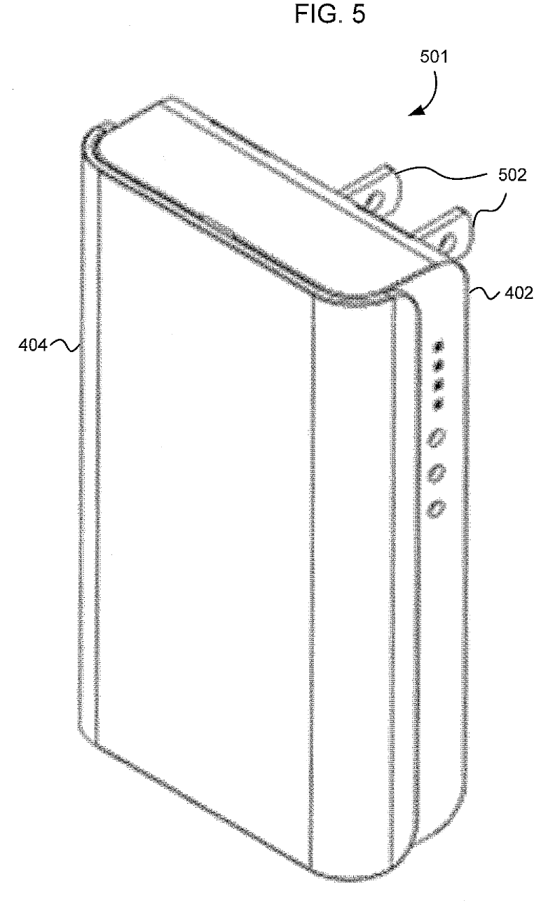

FIG. 5 is a perspective view of a wireless relay controller 501 configured to at least optionally receive AC power through an AC plug 502, according to an embodiment. The package includes a back plate 402 and a front cover 404, which may for example be made from a plastic or metal material. The back plate 402 and the front cover 404 may be formed as interlocking pieces that may be releasably coupled to one another. In other regards, the wireless relay controller 501 includes features described in conjunction with FIGS. 4A-4C.

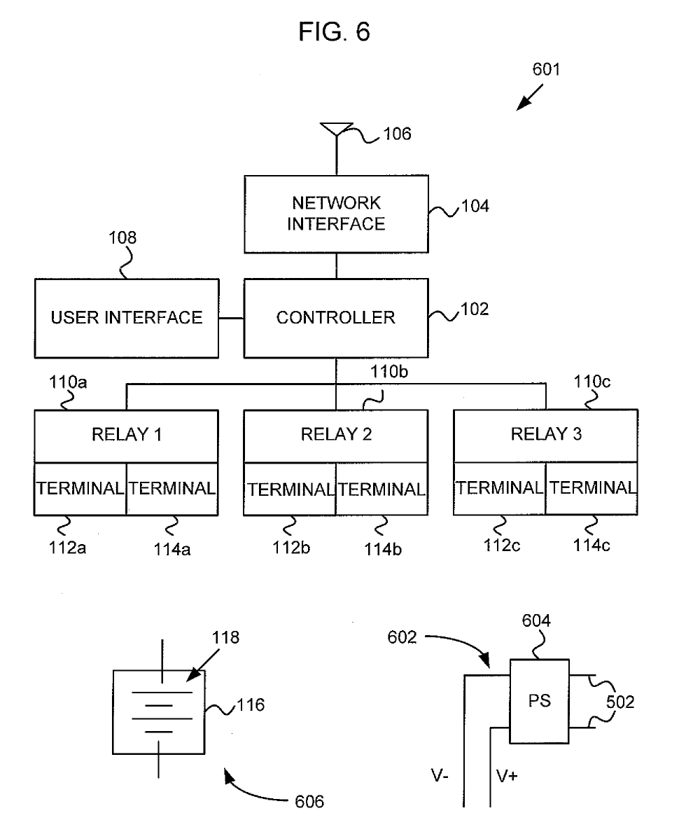

FIG. 6 is a block diagram of the wireless relay controller 601 configured to at least optionally receive AC power through an AC plug 502, according to an embodiment. The structure and functionality of the controller 102, network interface 104 and antenna 106, user interface 108, and relays 110a, 110b, and 110c may be as described above.

With respect to FIGS. 5 and 6, the wireless relay controller 501, 601 may include an AC plug 502. The AC plug 502 is operatively coupled to a power supply 604 configured to output DC voltages V+ and V− to power components associated with the controller 102, network interface 104 and antenna 106, user interface 108, and relays 110a, 110b, and 110c. Optionally, the AC plug 502 and power supply 604 may be configured as an AC power module 602. The AC power module 602 may be built into the wireless relay controller 501, 601 or may be offered as an option or accessory.

Optionally, the wireless relay controller 501, 601 may also include a battery holder 116 configured to receive one or more batteries 118 for powering the wireless relay controller 501, 601. For example, the battery holder 116 may be configured to receive three AAA cells. The AAA cells may be conventional alkaline, NiCd, NiMH, lithium-ion, lithium polymer, or other battery types. Optionally the battery holder 116 may be configured as a battery module 606. The battery module 606 may be built into the wireless relay controller 501, 601 or may be offered as an option or accessory.

Optionally, the AC power module 602 and the battery module 606 may be offered as mutually exclusive options or accessories. According to an embodiment, the AC power module 602 and battery module 606 may operate as a battery charger or an AC power source with battery backup. For example, the AC power module 602 may receive or include sufficient logical control to maintain the batteries 118 in a state of charge, either as primary power or as backup power. According to an embodiment, the operation of the power sources 602, 606 for the wireless relay controller 501, 601 may be programmable to manage power consumption as a function of power availability and/or power cost. For example, the wireless relay controller 501, 601 may include logic to draw power while solar cells are producing power and run from batteries at night, or may include logic to draw power at night to load balance a utility and run from batteries during the daytime.

Optionally, the AC plug 502 may be moved or removed (with or without the power supply 602). Optionally, the AC plug 502 may be rotated or otherwise moved to a recessed position to allow mounting of the wireless relay controller 501, 601 against a flat surface such as a wall. Optionally, the AC plug 502 may provide substantially the entirety of mechanical coupling to a wall (whether or not AC power is provided to the AC plug). Optionally, the back plate 402 of the wireless relay controller 501, 601 may include optional or additional mounting features for mounting the unit to a wall.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A wireless relay controller, comprising:
a controller;
a network interface operatively coupled to the controller; and
at least one bi-stable relay operatively coupled to the controller;
wherein the controller and network interface are configured to remain in a sleep mode when not receiving a command.

2. The wireless relay controller of claim 1, wherein the controller is configured to wake up and actuate the at least one bi-stable relay responsive to receiving a command addressed to the network interface; and
wherein the controller and network interface are configured to resume sleep mode upon completion of the actuation.

3. The wireless relay controller of claim 1, wherein the network interface includes a ZigBee interface.

4. The wireless relay controller of claim 1, wherein the controller is configured to:
receive a first command;
determine a plurality of relay commands corresponding to the first command; and
actuate the at least one bi-stable relay a plurality of times corresponding to the plurality of relay commands.

5. The wireless relay controller of claim 4, wherein the at least one bi-stable relay includes a plurality of bi-stable relays; and
wherein actuating the at least one bi-stable relay a plurality of times corresponding to the plurality of relay commands includes actuating at least a portion of the plurality of bi-stable relays at least once each corresponding to the plurality of relay commands.

6. The wireless relay controller of claim 4, wherein the controller includes a microprocessor or microprocessor core and at least one computer memory; and wherein determining a plurality of relay commands corresponding to the first command includes accessing a lookup table in the at least one computer memory to determine the corresponding plurality of relay commands.

7. The wireless relay controller of claim 1, further comprising:
an AC plug configured to couple to a power outlet and mechanically support the wireless relay controller.

8. The wireless relay controller of claim 1, further comprising:
a battery holder;
a charging circuit configured to provide DC charging current to the battery holder; and
an AC plug configured to provide power to the charging circuit.

9. The wireless relay controller of claim 8, wherein the AC plug is configured to be moved or recessed to allow mounting the wireless relay controller against a flat surface.

10. The wireless relay controller of claim 1, further comprising:
at least two terminals operatively coupled to the at least one bi-stable relay and configured to connect to appliance control wires.

11. The wireless relay controller of claim 1, further comprising:
at least one AC socket operatively coupled to the at least one bi-stable relay and configured to selectively provide power to an AC plug coupled to the AC socket.

12. The wireless relay controller of claim 1, wherein the controller and network interface comprise an integrated device including a microprocessor core and a ZigBee radio interface.

13. A wireless relay controller, comprising:
a network interface configured to receive a first command from a network;
a controller operatively coupled to the network interface and configured to receive the first command and responsively generate output a plurality of relay actuation signals corresponding to the first command; and
one or more relays operatively coupled to the controller and configured to operate responsive to the plurality of relay actuation signals.

14. The wireless relay controller of claim 13, wherein the controller is configured to drive a plurality of relay actuations responsive to receiving a single first command.

15. The wireless relay controller of claim 14, wherein the controller includes a microprocessor or microprocessor core and at least one computer memory; and wherein the microprocessor is configured to determine the plurality of relay actuations corresponding to the first command by a process including accessing a lookup table in the at least one computer memory to determine the corresponding plurality of relay actuations.

16. The wireless relay controller of claim 13, further comprising:
an AC plug configured to couple to a power outlet and mechanically support the wireless relay controller.

17. The wireless relay controller of claim 16, wherein the AC plug is configured to be moved or recessed to allow mounting the wireless relay controller against a flat surface.

18. The wireless relay controller of claim 13, further comprising:
a battery holder;
a charging circuit configured to provide DC charging current to the battery holder; and
an AC plug configured to provide power to the charging circuit.

19. The wireless relay controller of claim 13, wherein the one or more relays include one or more bi-stable relays.

20. A method for operating a wireless relay controller, comprising:
receiving a first command via a network interface; and
responsive to the first command, performing a plurality of relay actuations.

21. The method for operating a wireless relay controller of claim 20, further comprising:
using a lookup table to determine the plurality of relay actuations corresponding to the first command.

22. The method for operating a wireless relay controller of claim 20, further comprising:
responsive to receiving the first command via the network interface, performing address validation and capability validation prior to performing the plurality of relay actuations.

23. The method for operating a wireless relay controller of claim 20, further comprising:
after performing the plurality of relay actuations, transmitting an acknowledgement message.

24. The method for operating a wireless relay controller of claim 20, further comprising:
responsive to receiving the first command, performing a wake up operation to move from a low power state to an operational state; and
after completing the plurality of relay applications, performing a go to sleep operation to move from the operational state to the low power state.

25. A method for operating a wireless relay controller, comprising:
receiving a first command with a wake-up circuit, the first command being addressed to a wireless relay controller;
performing a wake-up command responsive to the first command to wake a controller in the wireless relay controller from a sleep state;
actuating at least one bi-stable relay responsive to the first command; and
performing a sleep command to put the controller into the sleep state.

26. The method of claim 25, further comprising:
receiving a second command with the wake-up circuit, the second command not addressed to the wireless relay controller; and
not performing the wake-up command responsive to the second command.

27. A method for operating a wireless relay controller, comprising:
transmitting at least one configuration command to a wireless relay controller, the at least one configuration command including instructions to execute a plurality of relay actuations responsive to receipt of a complex actuation command; and
transmitting to the wireless relay controller, the complex actuation command.
